(19) United States
(12) Patent Application Publication
(10) Pub. No.: US 2021/0108082 A1
(43) Pub. Date: Apr. 15, 2021

(54) COMPOSITION AND MOULDED PART WHICH CAN BE PRODUCED BY MOULDING THE COMPOSITION

(71) Applicant: Patenta Asia Ltd., Hong Kong (CN)

(72) Inventors: Bernhard Duna, Baldam (DE); Antonio Siu Pak Tak, Mount Rosie Garden (SG)

(73) Assignee: Patenta Asia Ltd., Hong Kong (CN)

(21) Appl. No.: 16/606,990

(22) PCT Filed: Apr. 20, 2018
(86) PCT No.: PCT/EP2018/060154

§ 371 Date: Oct. 21, 2019

(30) Foreign Application Priority Data
Apr. 21, 2017 (EP) 17000693.6

(51) Int. Cl. C08L 97/02; C08L 27/06

(52) U.S. Cl. CPC C08L 97/02; C08L 27/06

(57) ABSTRACT

The present invention relates to a composition, comprising 30-65 wt. % PVC resin and 10-35 wt. % rice husk powder based on the total amount of the composition, wherein 40-70 wt. % of the rice husk powder have a particle size in the range of <150 μm (>100 mesh) and 30-60 wt. % of the rice husk powder have a particle size in the range of 249-150 μm (100 mesh). Furthermore, the invention refers to a molded part, obtainable by molding the composition by a molding process, preferably comprising foaming, (co)-extrusion, calendering, injection molding or 3D-printing.

### SUMMARY

The invention relates to a composition comprising a PVC resin and rice husk powder, wherein the rice husk powder has a specific particle size distribution. Furthermore, the invention relates to a molded part obtainable by molding the composition by a molding process.

### STATE OF THE ART

In the state of the art, compositions are known, which comprise PVC resins and rice husk powder, and which can be used e.g. for the production of wood imitations. These compositions were developed in particular to replace conventional wood-plastic composites (i.e. “WPC”) or HPL materials (“high pressure laminates”). Known PVC resin/rice husk powder compositions use rice husk powders, which have a relatively large particle size of e.g. 0.42 to 0.25 mm (see e.g. WO 2011/100995 A1). Further, DE 20 2013 007 232 U1, DE 20 2013 007 233 U1, DE 20 2013 007 234 U1, DE 20 20013 007 235 U1 and DE 20 2015 003 154 U1 describe for example compositions, which may contain a PVC resin and rice husk powder, wherein the rice husk powder has a particle size in a wide range from 0.42 to 0.10 mm. Also, WO 2016/192846 A1 describes a foil made of a material that comprises PVC and, for example, rice husk powder, wherein the rice husk powder has a particle size of 10 to 250 μm.

DE 10 2015 006 878 A1 discloses a foil with a wood-like appearance. DE 20 2013 007 267 U1 discloses a wood imitation made of natural fiber compound. US 2011/0045250 A1 discloses an extrusion process and a product manufactured thereby. However, these documents do not reveal any indication as to how, in particular, high-quality foamed products or thin molded parts can be reproducibly produced.

Due to the increasing demands on wood substitutes and the desire for new materials, there is a need for compositions that can be used in a variety of applications and in particular also have a relatively low density. With the compositions made of PVC and rice husk powder that are described in the state of the art, for example materials with a density of 1 g/cm³ cannot be produced or can only be produced with great effort. Also thin molded parts are often difficult to produce. Furthermore, particularly when using conventional rice husk powders with smaller particle sizes of 150 μm or less, their processing during the molding process is poor. This can be explained by the relatively large surface area per mass unit, which causes higher adhesive forces and thus a lower flowability.

### OBJECT OF THE INVENTION

For these reasons, there is still a need for compositions that allow the production of particularly low density foamed molded parts, as well as the production of thin molded parts.

Thus, the object of the invention is to provide compositions that are particularly suitable for the production of foamed plates or foils with a layer thickness of 3 mm or less, as well as molded parts made thereof.

### SHORT DESCRIPTION OF THE INVENTION

This object is solved by the composition according to claim 1. Preferred embodiments of the composition are described in sub-claims 2 to 10, which are also included in combination with each other. Further, the object is solved by the molded part according to claim 11. Preferred embodiments of the molded part are described in sub-claims 12 to 14, which are also included in combination with each other. Furthermore, the object is solved by the use according to claim 15. Additional designs result from the following detailed description. This describes the present invention particularly in connection with the composition according to the invention. The embodiments described there as preferred also apply to the process in accordance with the invention, the molded parts in accordance with the invention, as well as to the claimed use.

### DETAILED DESCRIPTION OF THE INVENTION

The composition according to the invention comprises 30-65 wt. % PVC resin and 10-35 wt. % rice husk powder, based on the total amount of the composition.

In preferred embodiments, the composition comprises 38-60 wt. %, preferably 40-58 wt. %, more preferably 49-55 wt. % PVC resin.

There are no specific limitations for the PVC resin. In particular, new PVC material or PVC recycling material or mixtures thereof can be used. For example, a PVC resin suspension with a K value of 50-70 is suitable. The K value is a number calculated from measurements of the viscosity of diluted solutions of a polymer and is a measure of the degree of polymerization or the molecular weight. The K-value is used as the resin specification. The term “PVC resin” refers to homopolymers of vinyl chloride and copolymers formed by polymerization of vinyl chloride with one or more comonomers such as ethylene, propylene or vinyl acetate.

In embodiments, the composition may comprise 15-32 wt. %, preferably 17-30 wt. %, more preferably 20-25 wt. % rice husk powder.

The quantity ranges mentioned above for the two components PVC and rice husk powder can be combined according to the desired application or property profile, e.g. 30 to 65 wt. % PVC and 20 to 25 wt. % rice husk powder, etc.

In embodiments, the weight ratio of the PVC resin and the rice husk powder in the composition is 1:1 to 3.5:1, preferably 1.5:1 to 3:1.5, more preferably 2:1 to 2.5:1. This weight ratio ensures a good miscibility of the individual components (also with the additional components as described below), i.e. particularly good homogeneity of the resulting compositions/molded parts.

The rice husk powder to be used according to the invention has the following particle size distribution: 40-70 wt. % of the rice husk powder have a particle size in the range of <150 μm (>100 mesh) and 30-60 wt. % of the rice husk powder have a particle size in the range of 249-150 μm (100 mesh). The particle sizes mentioned above, as well as the preferred particle sizes and particle size distributions described below, mean that the fractions mentioned can be determined and isolated by sieving processes. The fraction with the particle size 249-150 μm (100 mesh) means that the particles do not pass through a sieve with a sieve width of 100 mesh (see below).

The particle size and particle size distribution is determined by a sieving process using a sieving device from Filtra, Model “Iris FTL-0200” (instrument settings: Power: 5; Cycle: 0, Timer: 10 min.). The sample quantity is 100 g, taken at least approx. 20 cm from the surface of the container. The measurement is repeated 3 times. The result corresponds to the arithmetic mean of the three measured values. The sieves used are as follows: 40 mesh (>425 μm), 45 mesh (355-425 μm), 60 mesh (250-354 μm), 100 mesh (150-249 μm), the remainder is defined as particle size >100 mesh (<150 μm). The term “mesh” refers to the mesh size of the sieves according to “US Standard Sieve”. The smaller the mesh value, the larger the particle size.

In a preferred embodiment, the composition of the rice husk powder is such that 40-60 wt. % of the rice husk powder have a particle size in the range of <150 μm (>100 mesh) and 40-60 wt. % of the rice husk powder have a particle size in the range of 249-150 μm (100 mesh). It is also preferred that 20 wt. % or less, in particular 10 wt. % or less, of the rice husk powder have a particle size in the range of 250 μm or larger (<100 mesh).

In embodiments, the composition of the rice husk powder is selected such that 40-50 wt. % of the rice husk powder have a particle size in the range of <150 μm (>100 mesh), 40-50 wt. % of the rice husk powder have a particle size in the range of 249-150 μm (100 mesh), less than 15 wt. % of the rice husk powder have a particle size in the range of <150 μm (>100 mesh), and less than 15 wt. % of the rice husk powder have a particle size in the range of 354-250 μm (60 mesh), less than 3 wt. % of the rice husk powder have a particle size in the range of 424-355 μm (45 mesh), and less than 1 wt. % of the rice husk powder have a particle size in the range of greater than 425 μm (40 mesh).

By using a rice husk powder with such a specific particle size distribution, it is surprisingly possible to ensure good processability in a molding process despite of a relatively small particle size. At the same time, a high homogeneity of the material can be achieved. This makes it possible to obtain good aesthetic surface properties, such as optical and haptic appearance, and mechanical properties, particularly in the production of plates or foils with a thin layer thickness of 3 mm or less, or in the production of foamed molded parts. The improved aesthetic surface properties are, for example, a woodlike look and feel. The improved homogeneity is achieved by a reduced tendency to segregation and is expressed, for example, in improved mechanical properties, such as excellent values for the parameters tensile strength, tensile modulus, flexural strength, flexural modulus, an improved screw-trigger value and an improved IZOD impact strength (notched). Furthermore, an excellent thermal linear expansion, a high water-vapor diffusion resistance and a low water absorption are achieved. In particular, it is emphasized here that the molded parts in accordance with the state of the art described above comprise rice husk powder, which does not have the specific particle size distribution according to the composition of the invention and thus result in poorer properties, particularly in the case of foamed molded parts or foils or plate-like molded parts with a small layer thickness.

The used rice husks do not have any specific limitations, in particular with regard to certain types of rice. In a preferred embodiment, the rice husk material is pulverized using a conventional grinding process, followed, if necessary, by sieving processes to obtain individual fractions of particle sizes, so that the above-mentioned required particle size distribution is then achieved, for example by mixing individual fractions together (if the grinding process itself already produces the desired distribution, the sieving steps can be omitted). The particles of rice husk powder can be spherical or aspherical.

The rice husk powder can be surface-treated before use in the composition according to the invention in order to ensure good miscibility with the PVC resin. In particular, it is preferred that the rice husk powder is surface functionalized with silane or siloxane groups. This ensures a particularly good adhesion to the PVC resin.

In embodiments, the composition comprises one or more inorganic fillers. The inorganic fillers are preferably selected from the group comprising calcium carbonate, talc, mica, alumina, kaolin, silicate or titanium oxide, or mixtures thereof. Calcium carbonate is particularly preferred. The inorganic fillers are preferably contained in the composition in 0-30 wt. %, further preferably in 5-25 wt. %, more preferably in 10-20 wt. %, based on the total amount of the composition.

The composition contains in embodiments one or more additives, if necessary in addition to the inorganic fillers. These additives are preferably selected from the group comprising polymeric binders, preferably on the basis of thermoplastic materials, dyes and/or pigments, lubricants, PVC processing agents, such as plasticizers, foaming agents, UV stabilizers, thermal stabilizers, fire retardants, or mixtures thereof. The additives are preferably contained in 0-30 wt. %, further preferably in 5-25 wt. %, more preferably in 10-20 wt. %, based on the total amount of the composition.

For example, the polymeric binder has the function of binding moisture or solvents. Polymers of acrylates and/or methacrylates are preferred. Color pigments are e.g. chalk, titanium dioxide, carbon black, red iron oxide or ochre. Lubricants are e.g. fatty acid salts such as calcium stearate, fatty acid esters, fatty acid amides, paraffin waxes, polyethylene waxes or microcrystalline paraffin. PVC processing agents (e.g. heat and weather stabilizers, antioxidants, anti-aging agents, light stabilizers, ultraviolet absorbers, antistatic agents) are known to the skilled person and are available in a wide range on the market. In particular, polyethylene or chlorinated polyethylene is used as PVC plasticizer. Conventional foaming agents, which are not subject to specific limitations, can be used as foaming agents (or foam builders). In particular, chemical or physical foaming agents can be used. Physical foaming agents are for example surfactants or other surface-active substances, which, in addition to surface-activity, also have a certain film-forming capacity and thus promote the formation of foam liquids by blowing in gas. In the case of chemical foaming agents, foam formation is based on a chemical reaction that takes place under the generation of gas. Examples are polyurethane-based foaming agents or azo-based foaming agents. The amount to be added results from the manufacturer's instructions and is determined by the skilled person through simple routine tests. The resulting density of the foamed material can be adjusted by the amount of the foaming agent.

The chemical binder on the basis of thermoplastic materials has for example the function of removing moisture or solvents from natural fibers and strongly bounds or crosslinks with the “nonwoven web” or network of natural fibers. PVC processing aids can accelerate the fusion, improve melt strength, eliminate surface defects and reduce the “place out”. They can also enhance the metal release properties in the production process. The skilled person is familiar with suitable binders and processing aids in the field of PVC processing and a large selection is available on the market.

For fire-retardant compositions, e.g. 10-20 wt. % Al₂O₃, 5-10 wt. % Sb₂O₃ and 0.1-5 wt. % zinc borate are added as additives in preferred embodiments.

For foamed plates or profiles, e.g. 0.1-5 wt. % foaming agent, 5-10 wt. % lubricant and 5-15 wt. % acrylates are added as additives in preferred embodiments. Preferred embodiments for plates, profiles, which are impact-modified and which are produced by co-extrusion or injection molding, may also contain 1-10 wt. % lubricant and 5-15 wt. % acrylates.

In an embodiment, the composition exclusively comprises the PVC resin as polymer component, i.e. apart from the PVC resin, no other polymer components, such as polymer binders, are present. This results, among other things, in a high mechanical strength of the resulting molded part.

The composition preferably comprises 35-50 wt. % PVC resin and 15-35 wt. % rice husk powder, as well as 10-25 wt. % inorganic filler and 10-25 wt. % additives, based on the total amount of the composition.

The present invention also includes a molded part, which can be produced from the composition described above by using a molding process. The molding process is not subject to any specific limitations and preferably includes foaming, (co)extrusion, calendering, injection molding or 3-printing.

The skilled person is familiar with the setting of suitable process conditions. Furthermore, any commercially available machines can be used for the molding process. The operation is carried out according to the manufacturer's instructions. It is clear to the skilled person that the composition according to the invention must be sufficiently homogenized and liquefied under the processing conditions (e.g. temperature and pressure) so that it can be processed with the corresponding machines. Suitable processing conditions are either those specified by the manufacturer or determined by the skilled person by simple routine tests.

In a preferred embodiment, the molded part has the shape of a plate or foil, or the shape of a profile. The plate, foil or profile is preferably 3 mm thick or less, 2 mm thick or less, 1 mm thick or less. Due to the specific composition according to the present invention and in particular due to the specific particle size distribution of the rice husk powder, molded parts with such low layer thicknesses can be produced.

Corresponding plates/foils or profiles are usually produced by calendering or (co)extrusion. A suitable calendering process for foils with a thickness of 180 to 1000 μm is described for example in WO 2016/192846 A1.

Furthermore, the molded part is preferably foamed and has a density of less than 1 g/cm³. In embodiments, the density is 0.7 g/cm³ or less, preferably 0.5 g/cm³ or less, such as 0.4 g/cm³ or 0.3 g/cm³ (according to ISO 1183).

Before the molding process is carried out, the PVC powder is for example mixed in a mixer with rice husk powder and optional filler/additive (possibly at higher temperatures of e.g. 125-140° C.). After cooling, the mixture is formed at a temperature in the range of 150-210° C. or 160-175° C., for example. If necessary, a foamed product can be produced during or after molding by adding a foaming agent.

In an embodiment, a surface treatment is carried out after the composition has been molded, preferably by brushing, grinding, roughening, sandblasting, varnishing, oiling, glazing, printing, or mixtures thereof.

Brushing, grinding, roughening or sandblasting particularly removes the plastic skin formed on the surface of the molded part, resulting in good aesthetic surface properties such as a wood-like feel and appearance. By removing the plastic skin, the molded parts according to the invention also have good grip and slip resistance.

For example, the plastic skin can be removed by grinding. Grinding can be carried out for example with a grinding material such as sand paper or abrasive paper with a grain size in the range 24 to 60, for example by using an electrically operated hand grinder. In the case of grain size, a smaller numerical value corresponds to a coarser grain size and a higher numerical value to a finer grain size. A grain size of 24 is rather coarse and is suitable, for example, for removing layers of glue or varnish, while a grain size of 60 is rather medium and is used for example for coarse pre-grinding of raw wood surfaces. The appropriate grain size is selected by the skilled person in accordance with the practical conditions or the effect to be achieved.

The molded parts according to the invention can be printed, varnished, glazed or oiled on their surface, if necessary after an appropriate pre-treatment (e.g. priming), in particular due to the polar properties of the used PVC resin. The polar properties also allow easy bonding and give antistatic properties. In contrast, conventional wood/PE composites (WPCs) are not or only with great difficulty paintable, not bondable and not antistatic, due to the non-polar properties of PE.

Due to their stability, dimensional stability and absolute resistance to moisture influences such as rain, the molded parts according to the invention are superior to conventional wood/PE composites (WPCs) and also to many types of wood. The molded parts according to the invention are almost watertight. The PVC used is not hygroscopic and does not absorb water, thus preventing water from penetrating through damage to the surface, so that there is no infiltration of applied paint layers and no paint flaking. The molded parts according to the invention are therefore dimensionally stable, so that deformation in a natural way (e.g. by swelling or shrinkage) is not possible. Conventional wood/PE composites, on the other hand, swell under the influence of moisture. Lacquers no longer adhere because the penetrating water infiltrates them and thereby detaches them.

The color of the molded parts according to the invention can be adjusted by oiling, printing, varnishing or glazing. Depending on pigmentation and surface tint, various wood looks and haptics can be created, e.g. of tropical wood such as Burma Teak, Siam Teak, Java Teak or Aged Teak.

The molded part of the present invention may preferably be used as wood imitation, foamed substrate for laminates, building material, floor material, wall material, ceiling material for sills, veneers, window sashes, fences, furniture, vehicle, or housings for electrical appliances.

In particular, according to this invention, a foamed molded part, with or without the surface treatment described above, may serve as a replacement for conventional HPL (high pressure laminate) moldings.

The molded parts particularly have a tensile strength in the range of 5.0 N/mm² or more, preferably 8.0 N/mm² or more (measured with ISO 527). The tensile modulus is preferred in the range of 500 N/mm² or more, more preferred in the range of 700 N/mm² or more (measured with EN 789). The molded parts also preferably have a bending strength of 10 N/mm² or more, preferably 15 N/mm² or more. The bending E-module is preferably 500 N/mm² or more, more preferably 600 N/mm² or more (measured EN 310). The screw-trigger value is preferably 4000 N or more, more preferably 5000 N or more (measured with EN 320:2.011-07). The IZOD impact strength (notched) is preferably 2.0 kJ/m² or more, more preferably 2.5 kJ/m² or more (measured with ISO 180/1eA). The coefficient of linear thermal expansion is preferably in the range of 10×10⁻⁵ k⁻¹ (measured with ISO 11359-2/DIN 53852). Furthermore, the molded part has a high water vapor diffusion resistance, measured according to DIN EN ISO 125752, and a low water vapor absorption of at most less than 1% (24 hours), measured according to IN 317. Furthermore, the molded part has a high resistance to wood-destroying fungi, a high rotting resistance, as well as a high resistance to underground termites, and is therefore suitable for outdoor applications.

The following examples illustrate the present invention. It will be clear to the skilled person that these examples are not to be understood as limiting, but merely illustrate preferred aspects of the present invention.

### EXAMPLES

A rice husk powder composition in accordance with the definition of claim 1 (particle size distribution B, 50 wt. % of the rice husk powder having a particle size in the range of <150 μm (>100 mesh) and 50 wt. % of the rice husk powder having a particle size in the range of 249-150 μm (100 mesh)) was mixed with PVC and an additive compound, containing lubricant, PVC processing aid and foaming agent, in an extruder and then extruded with a foaming die. The resulting foams had a low density and at the same time excellent mechanical properties, comparable to non-foamed wood imitation according to the technical teaching of WO 2011/100995 A1.

The replacement of the rice husk powder to be used according to invention by a rice husk powder with in particular a larger content of large particles (particle size distribution A, 420-250 μm) resulted in a composition, which could not be processed to a foam with a comparable density. A comparison of the homogeneity of the foams by visual inspection of the obtained surfaces and of a cross-section showed that the composition according to the invention had a very homogeneous distribution of the components and also a very homogeneous foam structure, while with the composition not according to the invention, both inhomogeneities in the distribution of the components (lump formation) and a clearly inhomogeneous distribution of the cells of the foam could be observed. In addition to the disadvantages with regard to surface structure and foam structure, such products are also disadvantageous with regard to the higher weight, while at the same time not improving the mechanical properties.
1) A conventionally prepared dryblend of the following recipe is extruded on a parallel twin screw extruder (Everplast Mod. RSTEMD-110) (all amounts in wt. %):
S-PVC K 57-60: 40%
Filler, inorganic: 5%
Rice husks, particle size distribution A 35%
Stabilizer and lubricant package incl. foaming agent: 20%

With the help of a plate nozzle, a foamed plate with a width of 1220 mm and a thickness of 19 mm is produced. The foam is partly inhomogeneous and the foam bubbles are of different structure and size. The surface is very open-pored after preparation with an abrasive paper (24 grain). Partly, the foam structure (single, large open bubbles) is visible.

2) A conventionally prepared dryblend of the following recipe is extruded on a parallel twin screw extruder (Everplast Mod. RSTEMD-110) (all amounts in wt. %):
S-PVC K 57-60: 40%
Filler, inorganic: 5%
Rice husks, particle size distribution B 35%
Stabilizer and lubricant package incl. foaming agent: 20%
   With the help of a plate nozzle, a foamed plate with a width of 1220 mm and a thickness of 19 mm is produced. The minimum achievable foam density is 0.5 g/cm³.
   The produced foam is very fine and homogeneous, the bubbles are of uniform structure and size. After preparation with an abrasive paper (24 grain), the surface is still closed and its appearance and haptics are determined by the structure of the rice husk. The foam structure is not visible after grinding.

1. A composition, comprising 30-65 wt. % PVC resin and 10-35 wt. % rice husk powder based on the total amount of the composition, wherein 40-70 wt. % of the rice husk powder have a particle size in the range of <150 μm (>100 mesh) and 30-60 wt. % of the rice husk powder have a particle size in the range of 249-150 μm (100 mesh).

2. The composition according to claim 1, wherein 20 wt. % or less of the rice husk powder have a particle size in the range of 250 μm or greater (<100 mesh); and 40-50 wt. % of the rice husk powder have a particle size in the range of <150 μm (>100 mesh), 40-50 wt. % of the rice husk powder have a particle size in the range of 249-150 μm (100 mesh), less than 15 wt. % of the rice husk powder have a particle size in the range of 354-250 μm (60 mesh), less than 3 wt. % of the rice husk powder have a particle size in the range of 425-355 μm (45 mesh), and less than 1 wt. % of the rice husk powder have a particle size in the range of greater than 425 μm (40 mesh).

3. The composition according to claim 1, wherein the composition comprises 35-60 wt. % PVC resin.

4. The composition according to claim 1, wherein the composition comprises 15-32 wt. % rice husk powder.

5. The composition according to claim 1, wherein the rice husk powder is surface functionalized with silane or siloxane groups.

6. The composition according to claim 1, wherein a weight ratio of the PVC resin and rice husk powder in the composition is 1:1 to 3.5:1.

7. The composition according to claim 1 further comprising one or more inorganic fillers selected from calcium carbonate, talc, mica, alumina, kaolin, silicates or titanium oxide, or mixtures thereof, wherein the one or more inorganic fillers are present from 0-30 wt. % based on the total amount of the composition.

8. The composition according to claim 1 further comprising one or more additives selected from polymeric binders, thermoplastic materials, dyes and/or pigments, lubricants, PVC processing aids, plasticizers, UV stabilizers, thermal stabilizers, fire retardants, or mixtures thereof, the one or more additives present from 0-30 wt. % based on the total amount of the composition.

9. The composition according to claim 1 comprising 35-50 wt. %, PVC resin, 15-30 wt. % rice husk powder, 10-25 wt. % inorganic filler, and 10-25 wt. % additives, based on the total amount of the composition.

10. The composition according to claim 1, wherein the composition exclusively comprises the PVC resin as polymeric component.

11. A molded part, obtainable by molding the composition according to claim 1 by a molding process comprising foaming, (co)extruding, calendering, injection molding, or 3D-printing.

12. The molded part according to claim 11, wherein the molded part has the shape of a plate or foil with a thickness of 3 mm or less.

13. The molded part according to claim 11, wherein the molded part is foamed and has a density of less than 1 g/cm³.

14. The molded part according to claim 11, wherein, after the molding, a surface treatment is carried out, the surface treatment including brushing, grinding, roughening, sandblasting, varnishing, oiling, glazing, printing, or combinations thereof.

15. The molded part according to claim 1, the molded part configured as a wood imitation, a foamed substrate for laminates, a plate material, a building material, a flooring material, a wall material, a ceiling material, a material for sills, a veneer, a window sash, a door, a roofing shingle, a cladding, a facade, a fencing component, a furniture component, a vehicle component, or a housing for an electrical appliance.

16. The composition of claim 2, wherein 10 wt. % or less of the rice husk powder have a particle size in the range of 250 μm or greater (<100 mesh).

17. The composition of claim 1, wherein the composition comprises 40-58 wt. % PVC resin and 17-30 wt. % rice husk powder.

18. The composition of claim 17, wherein the composition comprises 49-55 wt. % PVC resin and 20-25 wt. % rice husk powder.

19. The composition of claim 1, wherein a weight ratio of the PVC resin to the rice husk powder from 1.5:1 to 3:1.

20. The composition of claim 19, wherein the weight ratio of the PVC resin to the rice husk powder is from 2:1 to 2.5:1.
